(19) United States
(12) Patent Application Publication
(10) Pub. No.: US 2005/0132228 A1
(43) Pub. Date: Jun. 16, 2005

(54) Data processing system and method

(75) Inventor: Stefan Ende, Koln (DE)

Correspondence Address: NORRIS, MCLAUGHLIN & MARCUS, 875 THIRD AVE, 18TH FLOOR, NEW YORK, NY, 10022, US

(73) Assignee: Bayer Aktiengesellschaft, Leverkusen (DE)

(21) Appl. No.: 10/967,650

(22) Filed: Oct. 14, 2004

(30) Foreign Application Priority Data
Oct. 20, 2003 (EP) 03024759.7

(51) Int. Cl. H04L 9/00

(52) U.S. Cl. 713/201

(57) ABSTRACT

The present invention relates to a data processing system comprising:
an online transactional processing system (102), the online transactional processing system having an authorization module (110) for assigning authorizations to users,
a computer (116) for coupling to the online transactional processing system, the computer having means (118, 120) for loading authorizations from the authorization module, storage means (124) for storing an authorization search profile and means (118, 120) for searching the loaded authorizations using the authorization search profile.

### FIELD OF THE INVENTION

The present invention relates to the field of data processing, and more particularly without limitation to managing user authorization.

### BACKGROUND AND PRIOR ART

Many functions performed by a business can be more effectively managed by using an enterprise resource planning system (ERP) to keep track of data associated with the function.

One of the most widely used ERP's is a system called SAP, produced by SAP AG, Walldorf, Germany.

ERP's are presently used to keep track of business functions such as finances, taxes, inventory, payroll, planning. Some ERP's additionally allow sharing of data across organizational units, which can greatly improve information flow through a company.

This problem is complicated by the common use of distributed computing systems to implement ERP's within corporations. These distributed computing systems spread out computational and data storage resources across computer networks to a large number of geographically separate computing nodes and corporate functions. Consequently, a distributed computing system exposes sensitive data to greater risk of loss, unauthorized modification and unauthorized access than exists in a more centralized computing system.

Providing such sharing can therefore significantly complicate the process of ensuring security for the underlying database system.

Techniques presently used to provide security in ERP's (database systems) implement security by providing a security profile for each user of the database system. A security profile specifies certain actions (or activity tasks) that a user is allowed to perform on or with the database. Each user is usually assigned to a specific security profile, and each user is only allowed to perform the actions specified in the security profile.

SAP provides for certain basic profiles and user authorizations but is generally not designed to adequately reflect each customers specific organizational needs right off the shelf.

If the responsibility to create and assign security profiles is given to system administrators, a problem can arise if potentially hundreds of system administrators, located at different sites within a corporation, are charged with the task of creating and assigning security profiles to users. It becomes almost impossible to exercise control over security in such an environment without unreasonably hindering access to the database system. A system administrator in a small branch office knowingly or unknowingly can potentially give a low-level clerk access to unneeded corporate information.

Additionally, the task of managing security is presently in the hands of system administrators, who usually maintain system security by inputting cryptic commands into a database security system. Business managers, who are not familiar with this cryptic information, cannot readily oversee the work of security administrators. Thus, a critical oversight function is lacking.

Another way of implementing security profiles is sometimes implemented via some centralized system for security that determines what users or user groups should have access to a particular type of information.

U.S. Pat. No. 6,005,571 describes a method for managing security in a database system. The method includes producing a plurality of task groups, the task groups including actions that may be performed on the database. Functional roles are created from these task groups, and a security profile for a user is created by assigning to the user at least one functional role. In one embodiment, the security profile for a user may only be created by assigning functional roles to users. Thus, users may only perform actions on the database that are dictated by defined task groups and functional roles. This allows database security to be controlled by controlling definitions of task groups and functional roles, without requiring exhaustive examination of security profiles for large numbers of individual users. The patentee mentions an audit security module that includes tools that allow a security administrator to determine what users are allowed to perform specific functions on the database without giving any specifics. It can be assumed that the audit security module is closely related to the regular audit trail/audit log functionalities of the regular ERP/SAP system.

The SAP authorization system is very complex and detailed. It consists of a huge amount of connected data, such as composite activity groups/roles, activity groups/roles, composite profiles and profiles containing authorizations and their objects, fields and values.

Due to this high complexity it is not easy to have an overview over users and their authorizations in order to check and monitor critical authorizations and accumulations of authorizations.

SAP itself provides an audit report of it's user authorization system (RSUSR002) for SAP R/3.

The central rights engine is usually not well equipped to detect business critical accumulation of rights. It may well be that critical combination of rights can accumulate in a single user profile with or without the knowledge of the respective user. A problem can also arise in the case of business or organizational changes without adjusting the authorization system accordingly. The actual situation of authorization setup will evolve more and more away from the original rights setup and it may well be that a critical combination of rights can accumulate in a single user or in composite activity groups/roles, activity groups/roles, composite profiles and profiles. Thus, to ensure a segregation of duties one should regularly monitor the authorization concept.

Therefore it is advisable for businesses to control or audit the security setup for their ERP from time to time.

Usually the control or the auditing of these individual authorizations is very time consuming and expensive, since it has to be performed by highly skilled professionals that take their personal time and control or audit certain individual rights.

By having persons perform that process it is inherently prone to human errors.

It would be an advantage to have an independent, fast, secure and reproducible way to audit the authorizations of individual users or composite activity groups/roles, activity groups/roles, composite profiles and profiles from time to time.

It would also be an advantage to have results of the developments of authorizations documented so as to follow and document managements efforts to alleviate an undesirable combination of authorizations in certain users and composite activity groups/roles, activity groups/roles, composite profiles and profiles.

It is also desirable to achieve the audit of the SAP user authorization concept without impeding the productive use of the ERP.

Another approach was taken by CSI Belgium (http://www.be-csi.com), last accessed Oct. 7, 2003) with a product called CSI AA (Authorization Auditor) that attempts to analyze the authorization concept by evaluating the actual user access profiles on the detailed level of data field values without disturbing the performance of the SAP system. This program works by downloading and importing at least 10 of the following 23 SAP tables (depending on the release of the CSI product and the release of SAP): ADRP, AGR_{—}1252, AGR_AGRS, AGR_DEFINE, AGR_PROF, AGR_TCODES, AGR_TEXTS, AGR_USERS, T000, TOBJT, TSTCP, TSTCT, USR02, USR03, USR11, USR13, USR21, USREFUS, UST04, UST10C, UST10S and UST12.

SAP R/3 provides an online transactional processing functionality. Data is updated in SAP R/3 in two different ways: synchronously and asynchronously. Synchronous updates are performed by the application itself, while the user is waiting for his or her transaction to come back. Asynchronous transactions usually are committed near-real-time, without the user having to wait for the update to complete; these updates are termed V1 or V2 updates in SAP R/3.

V1 denotes time-critical updates used for updating the actual transaction tables. V2 denotes non-time-critical updates used for updating statistic tables related to the transaction tables. For instance, after a sales order entry transaction is complete, the corresponding sales order tables would be updated in V1 mode, and the corresponding statistics table would be updated in V2 mode. The longer the task queues, the longer the updates will take. Depending on system load, the physical updates may take anywhere from a more or less immediate update to a couple of minutes.

There are two fundamental ways data is written to database tables in operational systems: with a delta change capture mechanism and without. Delta capturing mechanisms have been implemented in SAP R/3 updates in several variants: time stamps and delta queues.

System throughput is a critical performance measurement for an online transactional processing (OLTP) system as such systems are designed to process thousands or even millions of small transactions per day.

### SUMMARY OF THE INVENTION

In accordance with the present invention there is provided a data processing system that has an online transactional processing (OLTP) system with an authorization module for assigning authorizations to users. The data processing system has a computer for coupling to the OLTP system. The computer has means for loading authorizations from the authorization module and storage means for storing an authorization search profile. The computer searches the loaded authorizations using the authorization search profile.

The present invention is particularly advantageous as it facilitates to perform an off-line analysis of user authorizations of an online processing system. This has the advantage that the performance of the online processing system is not impacted substantially by performing the authorization analysis as the authorizations are loaded from the online system into the off-line system before the analysis is performed.

In accordance with a further preferred embodiment of the invention the computer has a user interface for a user's selection of first and second search modes for searching the loaded authorizations. The first search mode serves for searching of authorization profiles by means of the authorization search profile whereas the second search mode serves for searching users having assigned authorizations that match the authorization search profile. This facilitates analysis of the authorizations both on an authorization profile and on a per user level.

In accordance with a further preferred embodiment of the invention the authorizations are loaded in a tabular form which is searchable. For example, a table containing authorizations is loaded into the computer from the OLTP system. A sub-table is generated from the table; the sub-table only contains those authorizations that have at least one authorization component matching the authorization search profile. The sub-table is used as the basis for further analysis, e.g. for searching matching authorization profiles or users. The pre-filtering of the table to provide the sub-table is advantageous as it reduces the data processing load on the computer in order to perform the search. This is because the sub-table has a size that is substantially smaller than the original table such that performing the full search only on the sub-table substantially reduces the search processing load on the computer. This is particularly useful as it facilitates to use a standard computer to perform the authorization analysis, such as a personal computer, preferably a portable computer used by an auditor.

In particular the present invention provides a method for auditing an SAP user authorization system by downloading SAP authorization tables into an analytical tool, determining an audit set, i.e. an authorization search profile, having at least three values of an object-field-combination connected by an ‘AND’, calculating all the user's, profiles/composite profiles, activity groups/roles and composite activity groups/roles whose authorizations are meeting the conditions defined in the audit set to obtain a data set, and displaying the data sets.

### BRIEF DESCRIPTION OF THE DRAWINGS

In the following preferred embodiments of the invention are described in greater detail, by way of example only, making reference to the drawings in which:

FIG. 1 illustrates as Step 1 the processing of the selections of SAP tables,

FIG. 2 illustrates as Step 2 the user evaluation,

FIG. 3 illustrates an overview over an additional evaluation for the user information,

FIG. 4 illustrates a view of the linked data of table UST12,

FIG. 5 illustrates an Example Cluster,

FIG. 6 illustrates a Detected CALL and ALTERNATIVE transactions for transaction code SU01,

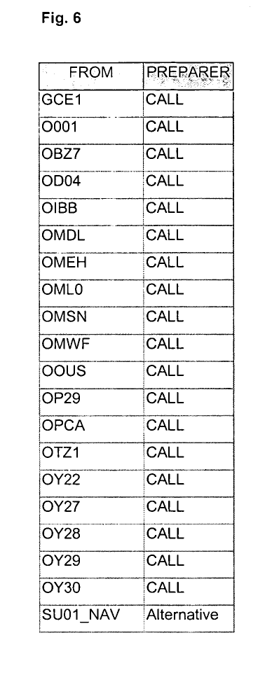

FIG. 7 illustrates a Screenshot with view on an extract of the user comparison matrix,

FIG. 8 illustrates a Screenshot with view on an extract of the profile comparison matrix,

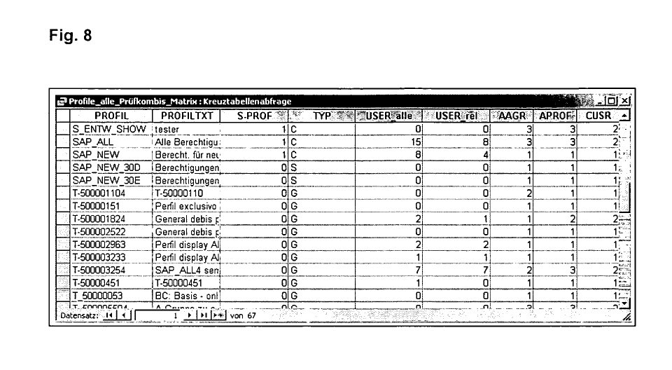

FIG. 9 is a block diagram of an embodiment of the data processing system of the invention,

FIG. 10 illustrates an embodiment of a method of the invention.

### DETAILED DESCRIPTION

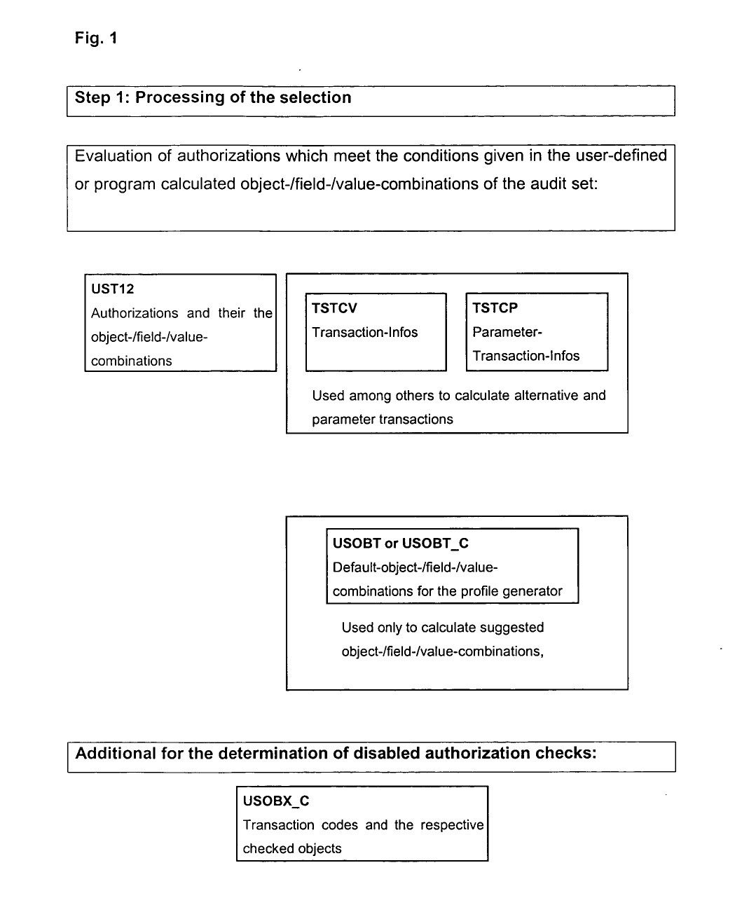

Step 1 in FIG. 1 provides an overview over the SAP tables used for processing of a selection. The evaluation of authorizations which meet the conditions given in the user-defined or program calculated object-/field-/value-combinations of the audit set.

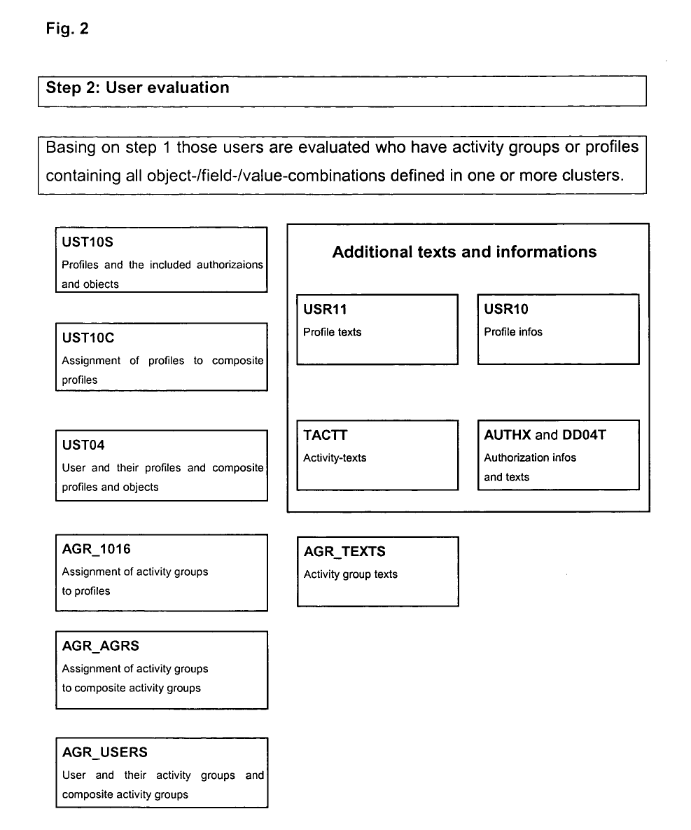

Step 2 in FIG. 2 provides an overview over the SAP tables used for the user evaluation. Based on step 1 those users are evaluated who have composite activity groups/roles, activity groups/roles, composite profiles and profiles meeting the conditions of all object-/field-/value-combinations defined in one or more clusters. It also contains a schematic example of SAP tables that were combined to calculate a subtable within the data evaluation software. USR10, USR11 and UST10C will be combined to form the subtable ‘PROFILE’.

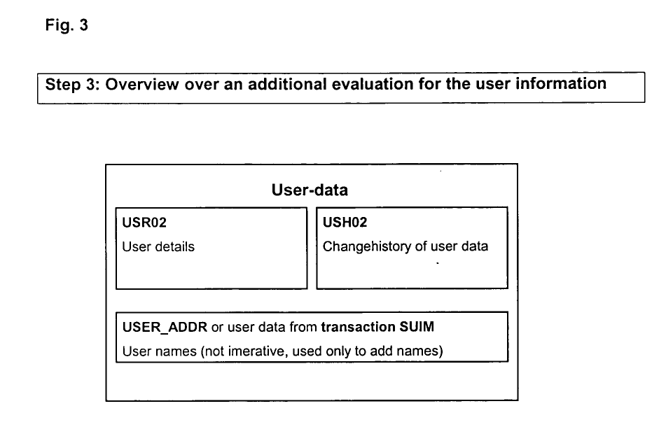

Step 3 in FIG. 3 provides a further overview over SAP tables that allow for an additional evaluation for the user information. It is also an example of two SAP tables (USR02 ans USH02) that are combined to one subtable, named ‘USER’, in the data evaluation software.

By data handling software the perswon skilled in the art will readily understand that there are several software programs on the market that will perform the required data handling operations. Examples include products by ORACLE, MICROSOFT, LOTUS and others. Specific examples include MICROSOFT ACCESS.

The person skilled in the art will readily understand the meaning of user. In one specific embodiment of the invention it is defined in the SAP handbook ‘Authorizations Made Easy’ (Release 4.6A/B), herein incorporated by reference.

The person skilled in the art will readily understand the meaning of profile. In one specific embodiment of the invention it is defined in the SAP handbook ‘Authorizations Made Easy’ (Release 4.6A/B), herein incorporated by reference.

The person skilled in the art will readily understand the meaning of composite profile. In one specific embodiment of the invention it is defined in the SAP handbook ‘Authorizations Made Easy’ (Release 4.A/B), herein incorporated by reference.

The person skilled in the art will readily understand the meaning of activity group/role. In one specific embodiment of the invention it is defined in the SAP handbook “Authorizations Made Easy” (Release 4.A/B), herein incorporated by reference.

The person skilled in the art will readily understand the meaning of composite activity group/role. In one specific embodiment of the invention it is defined in the SAP handbook ‘Authorizations Made Easy’ (Release 4.A/B), herein incorporated by reference.

The person skilled in the art will readily understand the meaning of authorization. In one specific embodiment of the invention it is defined in the SAP handbook ‘Authorizations Made Easy’ (Release 4.A/B), herein incorporated by reference.

The person skilled in the art will readily understand the meaning of object-field-value. In one specific embodiment of the invention it is defined in the SAP handbook ‘Authorizations Made Easy’ (Release 4.A/B), herein incorporated by reference.

The definitions are also mentioned in the SAP HANDBUCH SICHERHEIT UND PRÜFUNG, Praxisorientierter Revisionsleitfaden für R/3TM-Systeme, 3. Auflage, IDW-Verlag GmbH.

The person skilled in the art will readily understand the meaning of central processing unit, operating system, data storage device, display device and data input device.

Auditing an SAP user authorization system is not so much meant to mean creating or controlling logfiles as more to determine, if manual or automatic changes in the authorizations of users, profiles, composite profiles, activity groups/roles, or composite activity groups/roles lead to an unfavorable combination of authorizations for the company or parts of the company.

In one embodiment of the invention each SAP table is downloaded into a file. That enables the auditor or any interested person to perform subsequent audit operations on a different system or location. It also facilitates the comparison of several audits according to the invention at different times during business operations.

Although it is possible to obtain a data set with two SAP tables (for example a calculation using USR02 and USH02 could result in a list of all users including the date they were logged in the system the last time and were changed the last time) most calculations within the invention use three or more SAP tables.

In one embodiment of the invention the at least 3 SAP tables comprise UST12, TSTCV and TSTCP. One advantage of calculations performed with this set of SAP tables is indicated in the figures (step 1). The calculation will show if an object-field-value combination or several object-field-value combinations are included in authorizations assigned to an existing user, but is not yet able to show a specific user to which it is assigned. Furthermore it is possible to determine if alternate transactions, call transactions and even call-alternate transactions do exist and, by the data evaluation software, include all transaction codes considered as similar into the evaluation. In this embodiment the audit quality is anhanced. In comparison with manually evaluating these transactions the audit time may be considerably shortened. The functionality was unknown to the auditing community before the current invention.

Alternate transaction in the course of this application preferably describes a transaction that triggers the same program and/or dynpro than the audited transaction. Call transaction in the course of this application preferably describes a transaction that triggers another transaction. It usually describes a transaction that is triggered by an audited transaction, but it is also possible that the audited transaction is the triggered transaction. It follows that a call-alternate transaction usually describes a transaction that triggers another transaction that leads to the same program and/or dynpro than the triggered transaction.

In one embodiment of the invention at least 4 SAP tables are downloaded.

In one embodiment of the invention the at least 4 SAP tables comprise UST12, TSTCV, TSTCP and USOBX_C. One advantage of calculations performed with this set of SAP tables is that it can be evaluated whether authorization checks for the audited object-field-value combinations as defined in the audit set were accidentally or purposefully disabled by an authorized or unauthorized administrator.

In one embodiment of the invention the at least 4 SAP tables comprise UST12, TSTCV, TSTCP and USOBT_C. That enables the user to perform a more sophisticated audit, than downloading only 3 SAP tables. The table USOBT_C can in some cases be substituted by the table USOBT. By including the USOBT_C or USOBT-table the calculation enables the auditor readily to calculate the object-field-value combinations necessary to be able to execute a specific transaction and whether these object-field-value combinations are included in authorizations assigned to users. Thus, an audit set can be calculated and evaluated by the data evaluation software. Here it is also possible to determine alternate transactions, call transactions and call-alternate transactions and, by the data evaluation software, to include all transaction codes considered as similar into the evaluation.

In one embodiment of the invention at least 5 SAP tables are downloaded.

In one embodiment of the invention the at least 5 SAP tables comprise UST12, TSTCV, TSTCP and USOBT_C and USOBX_C. One advantage of calculations performed with this set of SAP tables is it can be evaluated whether authorization checks for the audited object-field-value combinations were accidentally or purposefully disabled by an authorized or unauthorized administrator.

In one embodiment of the invention at least 15 SAP tables are downloaded. In one embodiment of the invention the at least 15 SAP tables comprise the above mentioned tables UST12, TSTCV, TSTCP and the tables UST10S, UST10C, UST04, AGR_{—}1016, AGR_AGRS, AGR_USERS, USR11, USR10, TACTT, AUTHX, DD04T and AGR_TEXTS.

By using this set of tables it is possible to show the users to which the object-field-value combinations as defined in the audit set are assigned as well as all respective authorization details. It is also possible to see the profiles or composite profiles and/or activity groups/roles or composite activity groups/roles meeting the conditions of at least one of these given object-field-value combinations.

In one embodiment of the invention at least 16 SAP tables are downloaded. In one embodiment of the invention the at least 16 SAP tables comprise the above mentioned 15 tables and the table USOBX_C. This makes it possible also to evaluate which authorization checks for the audited object-field-value combinations as defined in the audit set were accidentally or purposefully disabled by an authorized or unauthorized administrator.

In another embodiment of the invention at least 16 SAP tables are downloaded. In one embodiment of the invention the at least 16 SAP tables comprise the above mentioned 15 tables and the table USOBT_C. This makes it also possible to calculate the audit set with the respective object-field-value combinations necessary to be able to execute a specific transaction and to evaluate this audit set by the data evaluation software.

In another embodiment of the invention at least 17 SAP tables are downloaded. In one embodiment of the invention the at least 17 SAP tables comprise all the above mentioned tables (UST12, TSTCV, TSTCP, USOBT_C, USOBX_C, UST10S, UST10C, UST04, AGR_{—}1016, AGR_AGRS, AGR_USERS, USR11, USR10, TACTT, AUTHX, DD04T and AGR_TEXTS). This makes it possible to perform all evaluations as described above.

There are additional tables that are needed to obtain additional informations e.g. user-details like the last date of login (table USR02) or text informations like the object texts (table TOBJT) or informations needed for further evaluations like the reconciliation of User-IDs with the data of Human Resources (PA-tables) in order to see User-IDs belonging to persons which are no longer employed.

Therefore, in one embodiment of the invention at least 25 SAP tables are downloaded. In one embodiment of the invention the at least 25 SAP tables comprise AUTHX, DD04T, USER_ADDR, USH02, USR02, USOBT_C, USOBX_C, USR10, USR11, UST04, UST10C, UST10S, UST12, AGR_AGRS, AGR_{—}1016, AGR_TEXTS, AGR_USERS, TACTT, TOBJT, TSTCA, TSTCV, TSTCP, PA0000, PA0002 and PA0105.

In one embodiment of the invention the tables are downloaded and imported into the data evaluation software all at once.

In one embodiment of the invention the tables are downloaded and imported into the data evaluation software consecutively with a possibility of a manual control of each imported table. This a very good variation of the invention to avoid errors occurring from the download and import and thus can save time during the audit.

It is one advantage of that embodiment that the amount of data evaluated can be reduced from the amount originally imported from the SAP tables.

In one embodiment of the invention the data evaluation software is a database system different than SAP. That enables the auditor to perform calculations in a different location than the audited company or the customer. Another advantage is the guaranteed consistency of the original downloaded data, that will not likely be altered over the course of an audit or in between an audit and a repeat audit.

In one embodiment of the invention the data evaluation software is Microsoft ACCESS.

It is a well known program, its main advantages for this application being compatibility, reliability, accessibility and various export functionalities.

In one embodiment of the invention the data evaluation software is using the database engine and many program elements of Microsoft ACCESS like tables, queries, forms, macros and others.

In one embodiment of the invention the database file in the data evaluation software (without the imported SAP tables) comprises less than 10 MB of data, preferably less than 5 MB, more preferably less than 2 MB. It is readily understood that it is always an objective to reduce memory usage. It is surprising though that the method of the invention can be performed on that little memory and with such high efficiency.

In one embodiment of the invention the audit set has at least one value containing a variable. This is a very important possibility of the invention. The variable enables the auditor to look for any value given to users for the respective defined object-field-combinations. This reduces the number of calculations sometimes by an order of magnitude or more. It is readily apparent that this is highly cost efficient. Programs of the state of the art can not evaluate variable field-values.

In another embodiment of the invention the audit set has a set of more than two different values for the same object-field combination connected by an ‘AND’. For each of these values there can be entered more than two other values connected by an ‘OR’. To the best of the inventor's knowledge, no system in the state of the art can do that. Therefore the present invention is more specific and versatile than other audit methods.

In one embodiment of the invention the determination of the audit set comprises a step writing authorization information of at least part of the audit set by a user having knowledge of the SAP user authorization system.

In one embodiment of the invention the determination of the audit set comprises a step writing of at least part of the audit set by a computer program using the SAP default values of the USOBT_C table. Based upon this table the audit set can be generated by entering only one transaction code and determining the respective object-field-value combinations by the data evaluation software.

In one embodiment of the invention the object-field-value-combinations are structured by having a cluster information for each object-field-value-combination. The object-field-value combinations can have an additional parameter (Auswahl) to further structure the audit set. This parameter is needed to define that certain values of the same object-field-combination should be connected by an ‘AND’ or an ‘OR’.

In one embodiment of the invention the audit set has more than two clusters, preferably more than 5, more preferably more than 15, and most preferably more than 50 clusters.

In one embodiment of the invention one cluster is combined preferably according to a critical task like a transaction/program or a critical combination of transactions/programs in SAP. This audit set or this part of an audit set can be defined once and be used for all further audits. It is also possible to save the entire audit set or the clusters in other programs like MS Excel and to copy them into the data evaluation software. It will be readily apparent to those skilled in the art, that this is a useful feature of this embodiment of the invention, since it can incorporate knowledge acquired from experienced auditors over time.

In one embodiment of the invention the audit set has more than 15, preferably 30, more preferably more than 100, and most preferably 1000 object-field-value-combinations. SAP offers more than 2.000 object-field combinations. Depending on the organizational business structure of a company using SAP it is easily possible to have hundreds or even thousands of single field-values for specific objects if only because the object S_TCODE, field TCD has approx. 20.000 possible values (one per transaction code). Even if not all of them are used and/or filled, programs of the state of the art might be in trouble, especially if the number of users exceeds 100, 1000, or even 10000 users.

In one embodiment of the invention the audited SAP user authorization system comprises more than 10, preferably 100, more preferably 1000, and most preferably 10000 users. The high number of object-field-value-combinations also allows a highly specific audit of complex organizational business structures that are sometimes encountered in large multinational firms.

In one embodiment of the invention the audit set comprises the evaluation of more than three authorization-objects, preferably more than 15 SAP-authorization objects, more preferably more than 16 SAP-authorization objects, more preferably more than 30 SAP-authorization objects and most preferably more than 100 SAP-authorization objects. SAP can not evaluate more than three authorization-objects. The higher number of objects allows a highly specific audit of complex authorizations. This is important because many programs require authorizations containing specific field-values of more than three objects as one is already needed for the transaction code (object S_TCODE). The SAP-program RSUSR002 can only evaluate up to three objects.

In one embodiment of the invention the audit set has more than two values connected by an ‘OR’ per object field. That is also an improvement over current systems of the state of the art like the SAP-report RSUSR002.

In one embodiment of the invention the audit set has at least two clusters of object-field-value combinations. A cluster is a section in an audit set used to divide one or more object-field-value combinations in order to evaluate them separately. This allows the auditor to audit several object-field-value combinations in parallel but enables the auditor at the same time to analyze the audit result for each cluster separately. In one embodiment of the invention within a cluster the object-field-value combinations can be identified by adding an additional parameter (SELECTION) that enables the auditor to perform ‘AND’ or ‘OR’ calculations regarding the values of an object-field combination. The current program used by the inventor defines that the same value for the parameter defines an ‘OR’ analysis whereas a different parameter within a cluster defines an ‘AND’ analysis.

In one embodiment of the invention the audit set with more than two clusters is calculated in one run, whereby the results can be displayed together or separately.

In one embodiment of the invention profiles/composite profiles as well as activity groups/roles and composite activity groups/roles will be displayed that only fulfill at least the defined field-values of one of the objects as defined in the audit set. That gives the advantage of evaluating critical profiles/composite profiles as well as activity groups/roles and composite activity groups/roles containing critical authorizations or critical combinations of them.

In one embodiment of the invention the audit set is a table comprising a row defining a cluster, a row defining an SAP-authorization object, a row defining the fields of the objects and a row defining the values for these fields.

In one embodiment of the invention the audit set is a table comprising a row defining a parameter, a row defining an SAP-authorization object, a row defining the fields of the objects and a row defining the values for these fields.

In one embodiment of the invention the audit set is a table comprising a row defining a cluster, a row defining a parameter (Selection), a row defining an SAP-authorization object, a row defining the fields of the objects and a row defining the values for these fields.

The parameter (Selection) row can be the second row. As described above, in one embodiment of the invention the audit set comprises a second row may be defining logical ‘AND’ or ‘OR’ combinations regarding the values of an object-field combination.

In one embodiment of the invention the method includes the step of calculating at least one alternate transaction code or several transaction codes and, by the data evaluation software, including an optional transaction code or transaction codes regarded as similar in the calculation in addition to those entered in the audit set.

In one embodiment of the invention the method includes the step of calculating at least one call transaction code or several call transaction codes and, by the data evaluation software, including an optional transaction code or transaction codes regarded as similar in the calculation in addition to those entered in the audit set.

In one embodiment of the invention the method includes the step of calculating at least one call-alternate transaction code or several call-alternate transaction codes and, by the data evaluation software, including an optional transaction code or transaction codes regarded as similar in the calculation in addition to those entered in the audit set.

In one embodiment of the invention at least one sub-table is calculated from the SAP tables.

An example includes a sub-table calculated from the USR02 und USH02 tables (FIG. 3) to show user details.

In one embodiment of the invention at least one composite sub-table is calculated from at least one SAP table and the calculated sub-table.

In one embodiment of the invention the data set of results is displayed as a matrix.

In one embodiment of the invention the matrix is a comparison matrix displaying all the users, having an indicator (row) with respect to the fulfillment of the audit set clusters and ordered according to a dataset identifier. An example of this dataset identifier may be the user name and an example of the ordering may include alphabetical ordering. This feature is useful to detect critical combinations of authorizations by comparing the cluster results. It is also useful to join different evaluations performed at a different time.

In one embodiment of the invention the matrix is a result matrix displaying only the users that fulfill the audit set.

In one embodiment of the invention all the users are displayed as a table comprising additional information on the minimum and maximum field-values of the objects defined in the audit set clusters in the form of a min-max column. This is a fast way to exclude possible critical combinations. In case a) that a user has a critical financial authorization I (for example maintaining vendor master data) for company code 1, 3, 4 and 7 and a certain other critical financial authorization II (for example entering of invoices) for company codes 9, 10, 11, 14, and 15 the nin-max-analysis will immediately be sufficient to show that there is no overlap between authorization I (1; 7) and II (9; 15).

The situation changes somewhat in case b) if in addition to the above mentioned case the authorization of the user includes for transaction I also the company code 17. Although there is no authorization problem in the system so far the min-max analysis will not be sufficient to immediately prove that, i.e. the results will show authorization I (1; 17) and II (9; 15). In a third case c) the user might obtain authorization I for business area 10. Although there is an authorization problem in the system so far the min-max analysis will not be sufficient to immediately prove that, i.e. the results will show authorization I (1; 10) and II (9; 15).

In one embodiment of the invention an analysis is provided to evaluate whether users have critical combinations of authorizations whose respective object-field-values are matching. In one embodiment of the invention these matches are shown in a detailed list. In another embodiment of the invention a comparison matrix displaying all the users, having an indicator (row) with respect to the evaluated authorizations whether they match. In one embodiment of the invention this matrix contains also an indicator (row) showing the details of the match like the number of values matching.

In one embodiment of the invention displaying all the users as a table comprising additional information on the object field value combination in the form of an identifier with respect to the status of the user (blocked, validity, last login date).

In one embodiment of the invention it is possible to save and/or export all results into another spreadsheet- or database-file This is an advantage, because it can be performed by an independent auditor without handing out the program.

In one embodiment of the invention the results of an audit performed on a first specific day can be compared with the results of an audit later than the first specific day.

In many auditing procedures it may be in the best interest of the audited company or the customer, if the implementation of the recommendations of a first audit will be re-audited in a later evaluation. It is a useful feature of the present invention that the data of a first audit may be stored on a first day and compared with the results of a day different from the first day, because alterations to the systems will not affect or even change results obtained on the first day.

The invention also relates to a computer having a central processing unit, an operating system, a data storage device, a display device and a data input device having loaded thereon a program enabled to perform a method for auditing an SAP.

In one embodiment of the invention the user-data can be reconciled with the SAP-Human Resource-data or imported personnel-data from another system than SAP. This reconciliation shows users which are not or no longer employees of the company.

In one embodiment of the invention the user names are compared in order to detect persons having multiple User-IDs. This evaluation compares not only the exact name but also identical substrings of at least 3, preferably 5 signs of the beginning or end of the first or last name.

In one embodiment of the invention multiple activity groups/roles, composite activity groups/roles or composite profiles can be detected.

In one embodiment of the invention the system profile parameters of the SAP-system can be analyzed and compared with suggested default-values whereby these suggested-default-values can be maintained by the auditor. This enables the auditor to check, whether the security-relevant settings of system profile parameters are meeting the requirements.

### EXAMPLE

In this example the data-tables were downloaded from SAP/R3, Release 4.0 b, b and saved as text-files. They were linked with the data evaluation software using pre-defined import-links. The data evaluation software used is a product by Bayer AG, Germany called “Authorization Audit Tool”.

All linked tables can be seen in the data evaluation software to check whether the download was complete and correct.

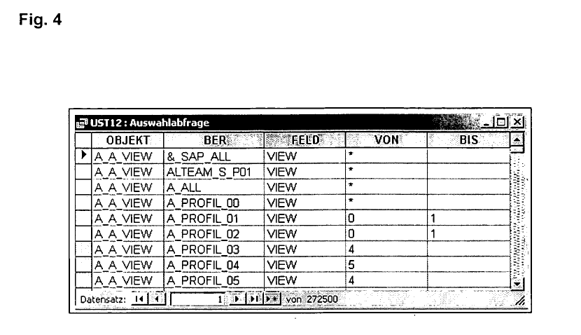

In one example the SAP table UST12 was checked in the data evaluation software as can be seen in FIG. 4.

To have a faster access some data from the SAP tables were combined into sub-tables which were used as basis for further evaluations. In the current example USR10, USR11 and UST10C were combined to form the sub-table ‘PROFILE’. The two SAP tables USH02 and USR02 were combined to one sub-table, named ‘USER’, in the data evaluation software.

The creation of the sub-tables was performed all at once, but in other examples it was performed consecutively with a manual control of each imported table.

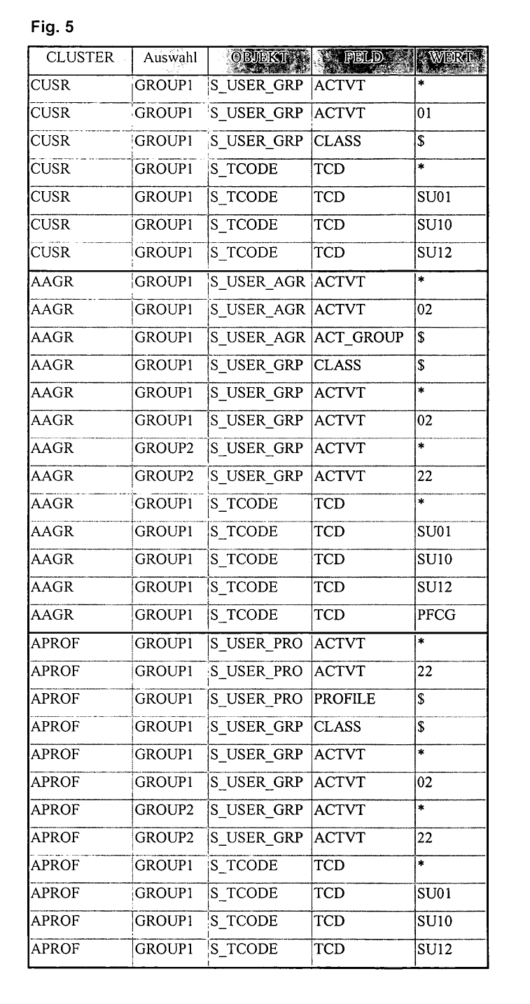

In this example an audit set was defined comprising three clusters of object-field-value-combinations, one giving the authorization to create users (CUSR), one to assign activity groups to users (AAGR) and one to assign profiles to users (APROF) as can be seen in FIG. 5.

The values of object-field combinations having the same parameter (row AUSWAHL) were calculated as a logical ‘OR’-condition and those having different parameters (here e.g. GROUP1 and GROUP2)) were calculated as a logical ‘AND’-condition, e.g. the values of the object-field combination S_USER_GRP, ACTVT in the clusters AAGR and APROF are defined as follows: (‘02’ OR ‘*’) AND (‘22’ OR ‘*’).

The $-sign is used to indicate a variable, which means that all object-field-combinations containing any value are meeting this condition.

The data evaluation software also evaluated call, alternative and call-alternative transactions. For the transaction code SU01 the following transaction codes were detected and considered as similar: GCE1 (CALL), O001 (CALL), OBZ7 (CALL), OD04 (CALL), OIBB (CALL), OMDL (CALL), OMEH (CALL), OML0 (CALL), OMSN (CALL), OMWF (CALL), OOUS (CALL), OP29 (CALL), OPCA (CALL), OTZ1 (CALL), OY22 (CALL), OY27 (CALL), OY28 (CALL), OY29 (CALL), OY30 (CALL), SU01_NAV (alternative).

The data evaluation software included these detected transaction codes automatically into the further calculations.

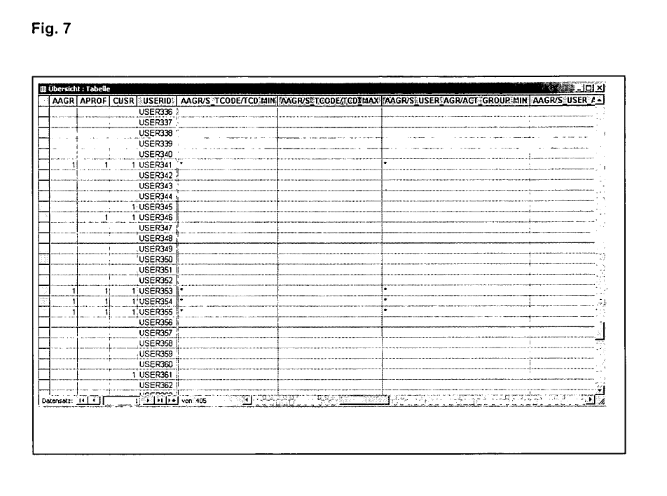

The results of this calculation were shown in detail or as a matrix displaying all the users, having an indicator (row) with respect to the fulfillment of the audit set clusters. FIG. 7 shows a screenshot of a part of the user comparison matrix In the same way the users were calculated, the profiles or composite profiles as well as activity groups/roles or composite activity groups/roles were evaluated.

The screenshot in picture 5 shows a part of the matrix of the profile evaluation containing all those profiles fulfilling at least the conditions of one object as defined in a cluster of the audit set. There is also shown to how many audit-set-defined-objects the requirements were met as well as all the users and all relevant users (valid, not blocked dialogue users) to whom the respective profiles were assigned to.

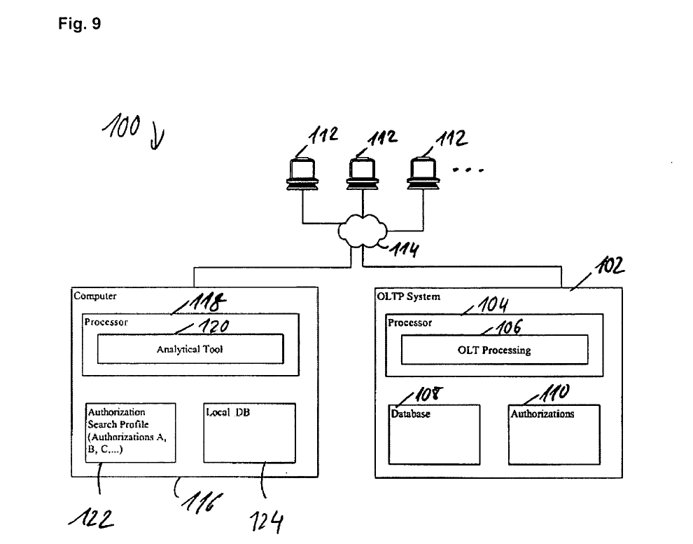

FIG. 9 shows a data processing system 100 that has an online transactional processing (OLTP) system 102. The OLTP system 102 has at least one processor 104 for running an OLTP application 106.

The OLTP system 102 has a database 108 for storing transactional data and an authorization module 110 for assigning authorizations to users and vice versa.

An authorization defines a user right, i.e. what a user can do, and to which data objects. For example, a user may be authorized to display and execute, but not change, a query. Authorizations are defined using authorization objects.

An authorization object has fields with values that specify authorized activities, such as display and execution, on authorized business objects, such as queries.

An authorization profile is a combination of multiple authorizations. An authorization profile can be created by means of a profile generator.

In a profile generator, an authorization profile corresponds to a role. A user assigned to the role automatically has the corresponding authorization profile. A user can be assigned to multiple roles.

Hence, in a typical OLTP system 102, such as SAP R/3, the authorization module 110 contains the authorizations in various forms which make it hard to analyze the existing authorizations efficiently.

A number of client computers 112 are coupled to the OLTP system 102 by means of a computer network 114. The client computers 112 can be utilized by authorized users to enter transactional data, initiate transactions, enter postings or various other online transactional processing tasks.

A computer 116, e.g. a laptop computer, can be coupled to the OLTP system 102 either directly or via the network 114. The computer 116 has at least one processor 118 for execution of an analytical tool 120. The analytical tool 120 is an application program that serves to analyze the user authorizations provided by authorization module 110.

The computer 116 has a storage 122 for storing an authorization search profile. For example, an authorization search profile is defined by a number of authorizations. An authorization profile matches the authorization search profile if it contains all authorizations specified in the authorization search profile. Likewise a user matches the authorization search profile if all authorizations that are assigned to that user are contained in the authorization search profile.

The computer 116 has storage 124 for storing a local database holding authorizations received from the authorization module 110.

In operation the computer 116 is coupled to the network 114. The analytical tool 120 is started by the user and existing authorizations are loaded from the authorization module 110 into the computer 116 from the OLTP system 102. The authorizations are stored in the storage 124. Preferably the authorizations are exported from the OLTP system 102 in tabular form. In other words, the computer 116 receives at least one database table that contains authorizations and stores the table in the storage 124.

The user can select a predefined authorization search profile stored in the storage 122 or he or she can enter a user defined authorization search profile or edit a predefined authorization search profile. In addition the user can select a search mode. For example, the user can select between the first search mode where matching authorization profiles are searched and a second search mode where matching users are searched.

In either case the table containing the authorizations stored in the storage 124 is transformed to provide a sub-table. The sub-table has a sub-set of the table entries of the table. All authorizations contained in the sub-table contain at least one of the authorizations specified in the search profile. A full search using the authorization search profile is then performed on the sub-table which substantially reduces the data processing load on the computer 116 in comparison to performing the full search on the complete table.

The authorization profile(s) or user(s), if any, that have been identified by the analytical tool 120 are outputted via a user interface provided by the analytical tool 120, e.g. on a computer screen coupled to the computer 116. If any authorization profiles and/or users have been identified that match the authorization search profile, the auditor that uses the computer 116 can take the appropriate action in order to limit the authorizations contained in the identified authorization profiles and/or user authorizations in order to avoid critical authorizations.

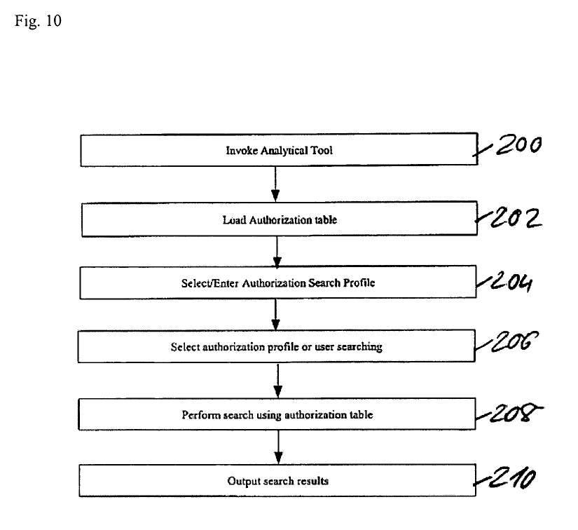

FIG. 10 shows a corresponding flowchart. In step 200 an auditor invokes the analytical tool. In response the analytical tool loads at least one authorization table from the OLTP system into the analytical tool (step 202). In step 204 the auditor selects or enters an authorization search profile. In step 206 the auditor selects a search mode, e.g. whether matching authorization profiles or users are to be identified. In step 208 the search is executed on the authorization table loaded in step 202. Preferably, the authorization table is pre-filtered to provide a sub-table containing only those entries that match at least one of the authorizations of the authorization search profile.

The search results are outputted in step 210. Preferably, the search results are outputted in tabular form for convenience of the auditor.

List of Reference Numerals

100 Data processing system
102 Online transactional processing (OLTP) system
104 Processor
106 Application
108 Database
110 Authentication module
112 Client computer
114 Network
116 Computer
118 Processor
120 Analytical tool
122 Storage
124 Storage

1. The data processing system comprising:
an online transactional processing system (102), the online transactional processing system having an authorization module (110) for assigning authorizations to users,
a computer (116) for coupling to the online transactional processing system, the computer having means (118, 120) for loading authorizations from the authorization module, storage means (124) for storing an authorization search profile and means (118, 120) for searching the loaded authorizations using the authorization search profile.

2. The data processing system of claim 1, the computer having a user interface (118, 120) for selecting a first or a second search mode for searching the loaded authorizations, wherein in the first search mode authorization profiles matching the authorization search profile are searched and in the second search mode users having assigned authorizations matching the authorization search profile are searched.

3. The data processing system of claim 1 or 2, wherein the means for loading the authorizations being adapted to load the authorizations in tabular form.

4. A data processing method of off-line analysis of authorizations assigned to users of an online transactional processing system, the method comprising:
loading authorizations from an authorization module (110) of the online transactional data processing system (102) into an off-line analytical system (116),
searching the loaded authorizations using an authorization search profile,
outputting a result of the search on a user interface.

5. The method of claim 4, further comprising selecting of first or second search modes by a user, wherein authorization profiles are searched in the first search mode and users are searched in the second search mode using the authorization search profile.

6. The method of claim 4 or 5, wherein the authorizations are loaded into the off-line analytical tool in a tabular form.

7. A computer program product, in particular digital storage medium, comprising computer executable instructions for performing the steps of:
loading authorizations from an authorization module (110) of the online transactional data processing system (102) into an off-line analytical system (116),
searching the loaded authorizations using an authorization search profile, outputting a result of the search on a user interface.

8. The computer program product of claim 7, further comprising selecting of first or second search modes by a user, wherein authorization profiles are searched in the first search mode and users are searched in the second search mode using the authorization search profile.

9. The computer program product of claims 7 or 8, wherein the authorizations are loaded into the off-line analytical tool as a table.

10. The computer program product of claim 9, further comprising generating a sub-table from the table, the sub-table containing only entries that have at least one authorization component matching the authorization search profile, wherein the search is performed on the sub-table.
